(19) United States
(12) Patent Application Publication
(10) Pub. No.: US 2003/0150494 A1
(43) Pub. Date: Aug. 14, 2003

(54) Gel hydration tank and method

(76) Inventors: Ronnie G. Morgan, Waurika, OK (US); Johnny W. Johnson, Duncan, OK (US); Rickey L. Morgan, Comanche, OK (US); James A. McGough, Duncan, OK (US); Michael R. Spaulding, Duncan, OK (US)

Correspondence Address: JOHN W. WUSTENBERG, P.O. BOX 1431, 2600 SOUTH 2ND STREET, DUNCAN, OK, 73536, US

(21) Appl. No.: 10/071,075

(22) Filed: Feb. 8, 2002

(51) Int. Cl. F17D 1/00

(52) U.S. Cl. 137/574

(57) ABSTRACT

The present invention relates to a gel hydration tank and method for hydrating gels for use in oil well treatment operations according to which a mixture of water and gel is introduced into the interior of the tank and flows through the tank before being discharged from the tank, whereby specific devices are used to deflect and/or re-direct fluid flow so as to increase the distance traveled for a given fluid volume element, which consequently increases the plug flow efficiency of the tank.

### BACKGROUND

This invention relates to a gel hydration tank and method for hydrating gels for use in oil and gas well treatment operations.

Well treatment fluids are often used in oil or gas wells for well completion procedures, to acidify the well formation, and/or increase the recovery of hydrocarbons from the well by creating fractures in the formations, and the like. Many well treatment fluids of this type are composed of water and polymer gel agents and are usually formed by transporting an appropriate polymer gel agent to the well site and mixing it with excess water before the mixture is transferred to a hydration tank. The mixture is introduced into the hydration tank and the finished fluid is withdrawn from the tank on a continuum, yet the mixture must be maintained in the tank an optimum time to allow the polymer gel agent to become hydrated to form a high viscosity well treatment fluid. Thus, the design of the hydration tank is important to ensure the above and thus form an optimum well treatment fluid.

### BRIEF DESCRIPTION OF THE DRAWINGS

FIG. 1 is a diagrammatic view of a typical oil well treatment operation incorporating a hydration tank.

FIG. 2A is a top plan, broken-away, view of a hydration tank according to one embodiment of the present invention.

FIG. 2B is a side elevational view of the hydration tank of FIG. 2A.

FIGS. 3 and 4 are cross-sectional views taken along the lines 3-3 and 4-4, respectively, of FIG. 2B.

### DETAILED DESCRIPTION

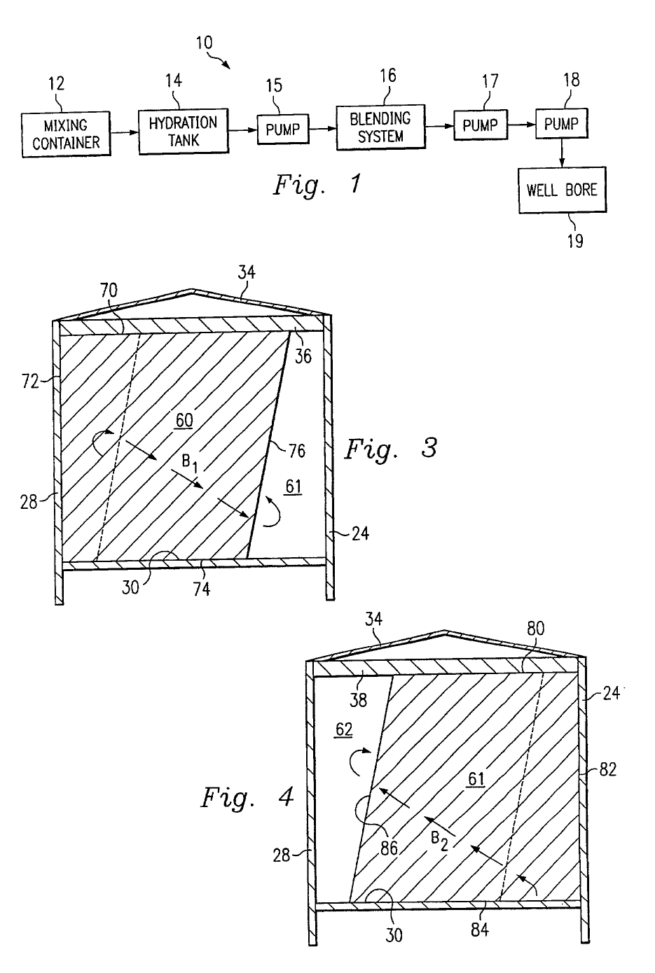

FIG. 1 illustrates a typical well treatment operation 10, where a high viscosity well treatment fluid is processed for introduction into subterranean well formations. In the well treatment operation 10, an appropriate polymer gel agent is transported to the well site, and placed in a mixing container 12. The polymer gel agent can include dry polymer additives, stabilized polymer slurries, aqueous liquid gel concentrates, and hydrocarbon-based liquid gel concentrates.

In the mixing container 12, the polymer gel agent is mixed with excess water and then transferred to a hydration tank 14 to allow time for the polymer gel agent to become hydrated to form a high viscosity well treatment fluid. Although the transformation from a polymer gel agent and water mixture to the resulting hydrated well treatment fluid is on a continuum, for the sake of simplicity the specification will refer to a fluid when it is not necessary to distinguish between the initial polymer gel agent and water mixture and the resulting hydrated well treatment fluid.

A pump 15 is used to transfer the hydrated fluid from the hydration tank 14 to a blending system 16, whereby sand or another proppant and other liquid additives are accurately metered and mixed with the hydrated gel. Then, another pump 17 transfers the mixture to high pressure pumps 18 that pressurize and transfer the final mixture to the well bore 19. In one embodiment, the well treatment operation 10 produces well treatment fluid substantially continuously. Thus, the hydration tank 14 must permit the flow of the well treatment fluid from the mixing container 12 to the pump 15 at a desired, substantially consistent, flow rate while allowing the fluid to remain in the hydration tank 14 for at least the hydrating period to ensure optimum viscosity for the resulting well treatment fluid. Thus, to establish an acceptable flow rate and residence time, the fluid should not “finger” ahead and enter the pump 15 before remaining in the hydration tank 14 for the hydration period.

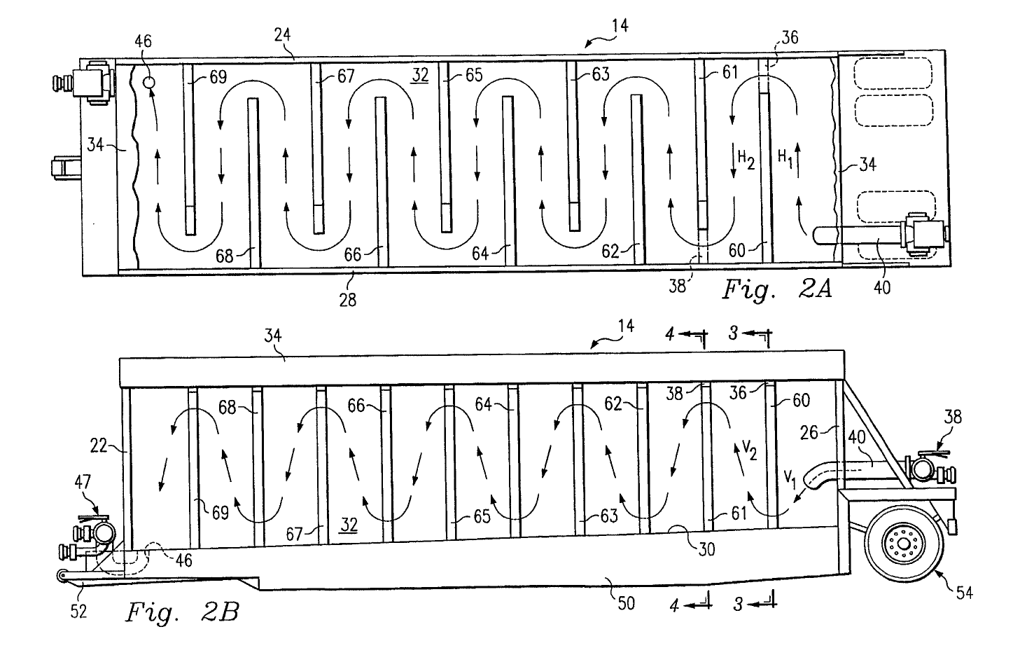

As shown in FIGS. 2A and 2B, the hydration tank 14 according to one embodiment of the present invention includes a set of walls 22, 24, 26, and 28 (wall 28 is removed for clarity in FIG. 2B), extending perpendicular to a floor 30 and attached to the floor 30 in any conventional manner to define a fluid-tight interior portion 32. A top 34 (partially shown in FIG. 2A) may be placed on top of the hydration tank 14 via structural members 36,38 to cover the interior portion 32.

An inlet pipe 40 extends through the wall 26 and adjacent to the wall 28 for receiving the polymer gel agent and water from the mixing container 12 (FIG. 1) and introducing the fluid into the interior portion 32. Fluid entry is controlled by mixing container 12. An inlet valve 38 is provided for isolating the hydration tank 14 from the mixing container 12. An outlet pipe 46 extends from the interior portion 32 and adjacent to the wall 24 to the exterior of the hydration tank 14 for allowing the discharge of the hydrated well treatment fluid from the hydration tank 14. Fluid exit is controlled by the pump 15. An exit valve 47 is provided for isolating the hydration tank 14 from the blending system 16. Thus, there is a general fluid flow through the interior portion 32 from the inlet pipe 40 to the outlet pipe 46.

The hydration tank 14 is mobile and includes a base 50 with an attached connector 52 at one end for coupling to a conventional motive source, such as a truck (not depicted). A wheel assembly 54 is attached to the other end of the base 50.

A plurality of weirs 60-69 are disposed in the interior portion 32 of the hydration tank 14 in a spaced, parallel relation to establish a flow path of the fluid from the inlet pipe 40 to the outlet pipe 46. As shown in FIG. 3, the weir 60 is a flat, plate-like structure having a top 70, a flat side 72, a bottom 74, and a slanted side 76. The top 70 is attached to the structural member 36, which spans between wall 24 and wall 28 and is positioned adjacent to the top 34 of the hydration tank 14. The flat side 72 is attached to the wall 28, and the bottom 74 is attached to the floor 30. The slanted side 76 is spaced from the wall 24 and creates a specific directional path for fluid to flow.

The weir 61 is shown in FIG. 4 and is also a flat, plate-like structure having a top 80, a flat side 82, a bottom 84, and a slanted side 86. The top 80 is attached to the structural member 38, which spans between wall 24 and wall 28 and is positioned adjacent to the top 34 of the hydration tank 14. The flat side 82 is attached to the wall 24, and the bottom 84 is attached to the floor 30. The slanted side 86 is spaced away from the wall 28, and creates a specific directional path for fluid to flow. Thus, the weir 61 is substantially similar to the weir 60, but is installed on the laterally opposing wall and is in an inverted orientation relative to the weir 60.

The weirs 62, 64, 66, and 68 are also connected to the wall 28 and are substantially identical to the weir 60; and the weirs 63, 65, 67, and 69 are also connected to the wall 24 and are substantially identical to the weir 61. Therefore, the weirs 62, 63, 64, 65, 66, 67, 68, and 69 will not be described in detail.

In operation, the fluid flows from the mixing container 12 (FIG. 1) and into the hydration tank 14 through the inlet pipe 40 (FIGS. 2A and 2B), before passing into and through the interior portion 32 of the hydration tank 14 and discharging from the outlet pipe 46. During this flow through the interior portion 32, the fluid is deflected by the weirs 60-69 in a manner to be described, and passes around the weirs 60-69, with each of the weirs 60-69 establishing its own fluid volume movement.

The general vector for the fluid volume movement for each of the weirs 60-69 is dependent on the above-described spaces between the slanted sides of the weirs and the relevant opposing wall. More particularly, the fluid entering the interior portion 32 of the hydration tank 14 from the inlet pipe 40 initially encounters the weir 60. The fluid volume movement around the weir 60 is shown in FIG. 3 by the reference arrow B₁. The fluid is blocked from passing between the weir 60 and each of the wall 28, the floor 30 and the top 34. Thus, the fluid must flow to the space between the wall 24 and the slanted side 76, generally to the right in FIG. 3. Also, since more fluid volume will pass through the relatively larger space between the wall 24 and portions of the slanted side 76 closer to the bottom 74, the flow is generally downwardly, as also shown by B₁.

The fluid next encounters the weir 61 described with reference to FIG. 4. The fluid is blocked from passing between the weir 61 and each of the wall 24, the floor 30 and the top 34. Thus, fluid must flow to the space between the wall 28 and the slanted side 86, generally to the left in FIG. 4 as shown by B₂. Also, since more fluid volume will pass through the relatively larger space between the wall 28 and portions of the slanted side 86 closer to the top 80, the flow is generally upwardly, as also shown by B₂.

It can be readily appreciated that each weir 60-69 establishes its own fluid volume movement, the even-reference numbered weirs 60, 62, 64, 66, and 68 producing fluid volume movements substantially similar to B₁, and the odd-reference numbered weirs 61, 63, 65, 67, and 69 producing fluid volume movements substantially similar to B₂.

Thus, the fluid flows in a direction in a horizontal plane of the hydration tank 14 as depicted in FIG. 2A and denoted by the reference arrow H₁; whereas the fluid then flows in another direction in a horizontal plane of the hydration tank 14 as denoted by the reference arrow H₂. The alternate juxtaposition of odd-reference numbered weirs 61, 63, 65, 67, and 69 and even-reference numbered weirs 60, 62, 64, 66, and 68, along the walls 24 and 28, respectively, and the staggered spaced openings, create an alternating pattern of flows H₁ and H₂.

Also, the fluid flows in a direction in a vertical plane of the hydration tank 14 as depicted in FIG. 2B and denoted by the reference arrow V₁; and in another direction in a vertical plane of the hydration tank 14 as denoted by the reference arrow V₂. As noted above, the alternate juxtaposition of the slanted sides of the odd-reference numbered weirs 61, 63, 65, 67, and 69 and even-reference numbered weirs 60, 62, 64, 66, and 68, create an alternating pattern of flows V₁, and V₂. Thus, the movement of fluid (H₁ and H₂, V₁ and V₂) through the hydration tank 14 in the above manner lengthens the distance traveled by the fluid, thus increasing the residence time to ensure hydration of the fluid in the hydration tank 14, and allows the use of faster flow rates.

### Variations and Equivalents

It is understood that the number of weirs disposed in the hydration tank 14 is disclosed only for illustrative purposes and that the invention contemplates the use of any number of weirs to create a desired flow rate, the number and size of the weirs being readily calculable based on the hydration tank 14 dimensions and hydrating period. Furthermore, the plug flow efficiency will increase with additional number of weirs, up to a limit.

Furthermore, it is understood that while the weirs show a slanted side for deflecting the fluid, an embodiment is also contemplated wherein the weirs have straight sides and the walls of the hydration tank 14 are slanted to deflect the fluid. Moreover, although a mobile embodiment of the hydration tank 14 is depicted in the drawings, it is understood that the hydration tank 14 may have various immobile embodiments.

It is also understood that all spatial references, such as “top”, “bottom”, “left”, “right”, “front”, “back”, “downwardly”, “upwardly”, “horizontal”, and “vertical” are for illustrative purposes only and can be varied within the scope of the invention.

Furthermore, it is understood that the essential flow patterns shown in the figures and described herein are for example only and the flow patterns may have directions other than horizontal and vertical.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. For example, small holes may be cut in the bottom of each weir (at the intersection of floor 30 and bottom 74 in FIG. 3 and floor 30 and bottom 84 in FIG. 4) to facilitate complete drainage during cleanup.

What is claimed is:

1. A hydration tank comprising:
a set of walls defining an interior portion;
an inlet in fluid communication with the interior portion for receiving fluid;
an outlet in fluid communication with the interior portion for discharging fluid; and
a first weir extending partially across the interior portion for deflecting fluid flow between the inlet and the outlet to increase the distance traveled by the fluid between the inlet and outlet.

2. The hydration tank of claim 1 further comprising a second weir extending partially across the interior portion in a spaced relation to the first weir for deflecting the fluid flow between the inlet and the outlet to further increase the distance traveled by the fluid between the inlet and outlet, the first and second weirs being constructed and arranged to cooperate with the walls to direct the fluid through the interior portion in different directions in a first plane and in different directions in a second plane.

3. The hydration tank of claim 2 wherein the directions of flow in each plane are opposite.

4. The hydration tank of claim 1 wherein the first weir is attached to a first wall and spaced from a second wall to define a first opening through which the fluid flows.

5. The hydration tank of claim 4 wherein the first weir deflects the fluid flow through the first opening to direct the fluid in a first direction in a first plane.

6. The hydration tank of claim 5 further comprising a second weir extending partially across the interior portion and in a spaced relation to the first weir for deflecting the fluid flow between the inlet and the outlet to further increase the distance traveled by the fluid between the inlet and outlet.

7. The hydration tank of claim 6 wherein the second weir is attached to the second wall and spaced from the first wall to define a second opening through which the fluid flows.

8. The hydration tank of claim 7 wherein the openings defined by the weirs are on opposite sides of the interior portion.

9. The hydration tank of claim 7 wherein the second weir deflects the fluid flow through the second opening to direct the fluid in a second direction in the first plane.

10. The hydration tank of claim 9 wherein the first direction is opposite to the second direction in the first plane.

11. The hydration tank of claim 9 wherein one surface of the first weir extends at an angle to the second wall.

12. The hydration tank of claim 11 wherein the size of the first opening varies so that more fluid passes through the relatively large portion of the first opening than through the relatively small portion of the first opening to direct the fluid in a third direction in a second plane.

13. The hydration tank of claim 12 wherein one surface of the second weir extends at an angle to the first wall.

14. The hydration tank of claim 13 wherein the second opening is inverted with respect to the first opening so that more fluid passes through the relatively large portion of the second opening than through the relatively small portion thereof to direct the fluid in a fourth direction in the second plane.

15. The hydration tank of claim 14 wherein the third direction is opposite to the fourth direction in the second plane.

16. The hydration tank of claim 1 wherein a first surface of the first weir is attached to a first wall and a second surface of the first weir is spaced from a second wall and extends at an angle to the second wall to define a first opening.

17. The hydration tank of claim 16 wherein the size of the first opening varies so that more fluid passes through the relatively large portion of the first opening than through the relatively small portion of the first opening to direct the fluid in a first direction in a plane.

18. The hydration tank of claim 17 further comprising a second weir extending partially across the interior portion and in a spaced relation to the first weir for deflecting the fluid flow between the inlet and the outlet to further increase the distance traveled by the fluid between the inlet and the outlet.

19. The hydration tank of claim 18 wherein a first surface of the second weir is attached to the second wall and a second surface of the second weir is spaced from the first wall and extends at an angle to the first wall to define an second opening.

20. The hydration tank of claim 19 wherein the openings defined by the weirs are on opposite sides of the interior portion.

21. The hydration tank of claim 19 wherein the second opening is inverted with respect to the first opening so that more fluid passes through the relatively large portion of the second opening than through the relatively small portion thereof to direct the fluid in a second direction in the plane.

22. The hydration tank of claim 21 wherein the first direction is opposite to the second direction in the plane.

23. A method of providing a flow rate of a fluid in a hydration tank, comprising the steps of:
providing an inlet in fluid communication with an interior portion of the hydration tank for receiving fluid;
providing an outlet in fluid communication with the interior portion of the hydration tank for discharging fluid; and
deflecting fluid flow between the inlet and the outlet to increase the distance traveled by the fluid between the inlet and outlet.

24. The method of claim 23 wherein the step of deflecting directs the fluid through the interior portion of the hydration tank in different directions in a first plane and in different directions in a second plane.

25. The method of claim 23 wherein the step of deflecting directs the fluid in a first direction in a first plane.

26. The method of claim 25 wherein the step of deflecting directs the fluid in a second direction in the first plane.

27. The method of claim 26 wherein the step of deflecting directs the fluid in a third direction in a second plane.

28. The method of claim 27 wherein the step of deflecting directs the fluid in a fourth direction in the second plane.

29. The method of claim 23 wherein the step of directing comprises providing at least a first opening in the interior portion through which the fluid flows to direct the fluid in a first direction in a first plane.

30. The method of claim 29 further comprising the step of varying the size of the first opening so that more fluid passes through the relatively large portion of the first opening than through the relatively small portion thereof to direct the fluid in a second direction in a second plane.

31. The method of claim 30 wherein a second opening is provided in the interior portion in a spaced relation to the first opening to direct the fluid in a third direction in the first plane.

32. The method of claim 31 further comprising the step of varying the size of the second opening so that more fluid passes through the relatively large portion of the second opening than through the relatively small portion thereof to direct the fluid in a fourth direction in the second plane.

33. The method of claim 29 wherein a second opening is provided in the interior portion in a spaced relation to the first opening to direct the fluid in a second direction in the first plane.

34. The method of claim 33 further comprising the step of varying the size of the first opening so that more fluid passes through the relatively large portion of the first opening than through the relatively small portion thereof to direct the fluid in a third direction in a second plane.

35. The method of claim 34 further comprising the step of varying the size of the second opening so that more fluid passes through the relatively large portion of the second opening than through the relatively small portion thereof to direct the fluid in a fourth direction in the second plane.

36. A method of establishing flow path for fluid through a hydration tank, comprising the steps of:
installing a first weir extending partially across an interior portion of the hydration tank for deflecting a fluid flow between an inlet and an outlet; and
installing a second weir extending partially across the interior portion of the hydration tank, and in an inverted orientation and on an opposite side of the interior portion relative to the first weir.
